(19) United States
(12) Patent Application Publication
(10) Pub. No.: US 2021/0409376 A1
(43) Pub. Date: Dec. 30, 2021

(54) FIREWALL RULE STATISTIC MINI-MAPS

(71) Applicant: VMWARE, INC., Palo-Alto, CA (US)

(72) Inventors: ARUN YESHWANTRAO NAGARGOJE, Pune (IN); Shrinivas Sharad Parashar, Pune (IN)

(21) Appl. No.: 16/997,084

(22) Filed: Aug. 19, 2020

(30) Foreign Application Priority Data
Jun. 30, 2020 (IN) 202041027837

(51) Int. Cl. H04L 29/06

(52) U.S. Cl. CPC H04L 63/0263; H04L 63/20

(57) ABSTRACT

Described herein are systems, methods, and software to manage usage statistics associated with firewall rules in a computing network. In one implementation, a method of operating a firewall summary service includes identifying a sequence of firewall rules for a computing environment and monitoring usage associated with each of the firewall rules. The method further includes generating, for display, a summary to indicate the sequence of the firewall rules with the usage associated with each of the firewall rules.

### RELATED APPLICATIONS

Benefit is claimed under 35 U.S.C. 119(a)-(d) to Foreign Application Serial No. 202041027837 filed in India entitled “FIREWALL RULE STATISTIC MINI-MAPS”, on Jun. 30, 2020, by VMware, Inc., which is herein incorporated in its entirety by reference for all purposes.

### TECHNICAL BACKGROUND

Computing networks employ firewalls to provide micro-segmentation and security for computing nodes in the computing networks. These computing nodes may comprise virtual machines, containers, physical computing systems, or other computing endpoints. When a communication is identified, a firewall may identify attributes of the communication, such as source and destination internet protocol (IP) addresses, source and destination media access control (MAC) addresses, protocol, or some other attribute, and apply an action based on a rule that matches the identified attributes. These actions may be used to permit the communication, block the communication, generate a log for the communication, or perform some other action.

In some implementations, to effectively manage a computing network, an administrator may desire to monitor communication statistics for the network. However, difficulties can arise in efficiently and effectively providing the required information to the administrator, such that the administrator can quickly identify problems and changes to the networking configuration.

### SUMMARY

The technology described herein manages the generation of summaries for firewall rule statistics. In one implementation, a firewall summary service identifies a sequence for applying firewall rules to communications in a computing network. The firewall summary service further monitors usage associated with each firewall rule of firewall rules in the computing network and generates a summary to indicate the sequence of the firewall rules and the usage associated with each of the firewall rules.

### BRIEF DESCRIPTION OF THE DRAWINGS

FIG. 1 illustrates a computing environment to monitor firewall rule statistics according to an implementation.

FIG. 2 illustrates an operation to monitor and summarize firewall rule statistics according to an implementation.

FIG. 3 illustrates an operational scenario of generating a summary from firewall rule statistics according to an implementation.

FIG. 4 illustrates a summary according to an implementation.

FIG. 5 illustrates an overview of a summary according to an implementation.

FIG. 6 illustrates a firewall summary computing system according to an implementation.

### DETAILED DESCRIPTION

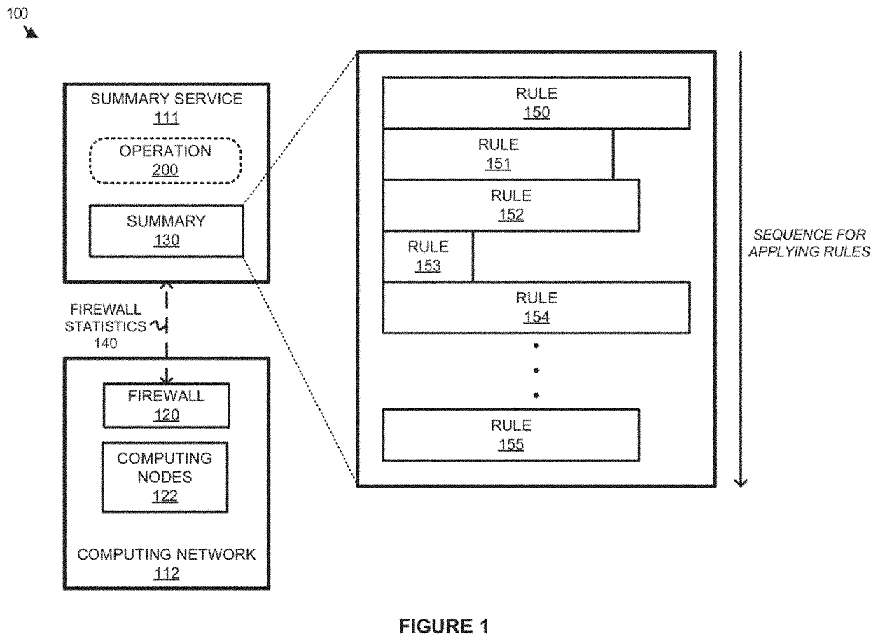

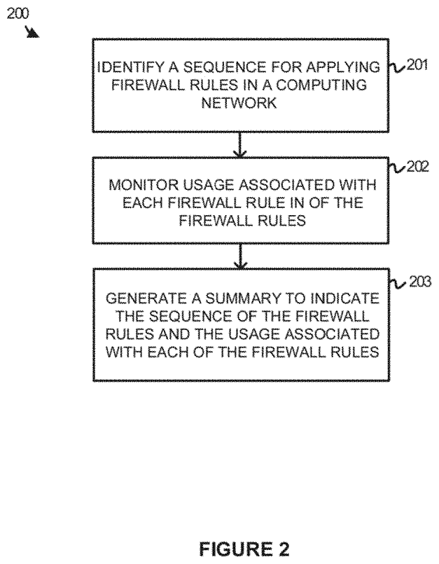

FIG. 1 illustrates a computing environment 100 to monitor firewall rule statistics according to an implementation. Computing environment 100 includes summary service 111 and computing network 112. Summary service 111 includes summary 130 with statistics for firewall rules (rules) 150-155 and provides operation 200 that is further described below with respect to FIG. 2. Computing network 112 further includes computing nodes 122 and firewall 120, wherein firewall 120 applies firewall rules 150-155 to communications for computing nodes 122.

In operation, computing nodes 122 execute in computing network 112 to provide various operations for an organization. Computing nodes 122 may comprise physical computing systems, such as desktop computers, servers, and the like, and may further include virtualized endpoints, such as virtual machines or containers. To provide network connectivity for computing nodes 122, firewall 120 is implemented, wherein firewall 120 may comprise a physical device or may be implemented as a distributed firewall across multiple computing systems. Firewall 120 is used to provide micro-segmentation and security for computing nodes 122, wherein firewall 120 may apply firewall rules 150-155 to ingress and/or egress communications for computing nodes 122. Each firewall rule of firewall rules 150-155 may associate one or more attributes identified in the communication with an action to be applied to the communication. The attributes may include source and destination internet protocol (IP) addresses, source and destination media access control (MAC) addresses, protocol, or some other attribute. The actions may include blocking the communication, permitting the application, generating a log of the communication, or some other action.

In some implementations, an administrator may generate firewall rules that associate security groups or other computing element tags to actions. For example, a firewall rule may be generated that permits packets to be sent from computing elements associated with an application tag to computing elements associated with a database tag. After the firewall rule is created by an administrator, firewall 120 may apply the rules by translating the application tags to addressing attributes identifiable in the communicated packets. Thus, the aforementioned firewall rule may be applied by allowing packets from IP addresses associated with the application tag to IP addresses associated with the database tag.

As depicted in summary 130, firewall rules 150-155 are applied to a communication in a sequence defined as part of the networking configuration, where the attributes in a communication are first compared against firewall rule 150 and subsequently applied to each following rule until a match is identified. For example, a packet generated by a computing node in computing nodes 122 may have attributes that are compared to each firewall rule in firewall rules 150-155 until a match is identified. Once a rule matching the attributes is identified, the action associated with the rule may be applied to the packet, while any remaining rules may be ignored for the packet.

As firewall 120 applies the firewall rules, summary service 111 may monitor firewall statistics 140 to determine usage associated with each of the firewall rules. Firewall statistics 140 may be provided to summary service 111 as hits to each of the firewall rules occur, at periodic intervals, or at some other period. In some implementations, firewall statistics 140 may be stored in a log or database, wherein summary service 111 may access the log or database to generate summary 130. As an example, a communication directed at a computing node in computing nodes 122 may hit or qualify for firewall rule 154. When the hit is identified, the hit may be logged by firewall 120, such that summary service 111 can identify the hit and use the hit to generate summary 130. In some implementations, a firewall may be implemented as a distributed firewall across one or more host computing systems for virtual nodes (virtual machines, containers, or other virtualized endpoints). Each of the firewall instances on the host computing systems may identify hits associated with the rules and provide statistics for the hits to summary service 111. Summary service 111 may be located on a host with an instance for the distributed firewall or may be located on another computing system. The statistics from each of the hosts may be provided periodically, during traffic downtimes at each of the hosts, in response to a request from summary service 111, or at some other interval. In some examples, the information from the hosts may be stored in one or more log files or other data structures by summary service 111 to generate the visual summary.

In the example of computing environment 100, summary 130 is represented as a bar chart or mini-map, wherein each bar of the bar chart corresponds to a firewall rule of firewall rules 150-155. The bars of the bar chart are organized to indicate the sequence of firewall rules 150-155 as they are applied by firewall 120, and the height or length of each of the bars corresponds to the usage of the firewall rule for that bar. Although demonstrated as a bar chart, it should be understood that a summary may take different forms to represent sequencing for applying firewall rules and usage associated with the firewall rules. The usage for the firewall rules may include a total quantity of hits for each firewall rule, a ratio of hits for each firewall rule in relation to the total number of hits for the firewall, a total number of packets or bytes associated with each firewall rule, or some other usage metric. In some examples, summary 130 may be generated in response to a request from a user or administrator associated with the computing network, however, it should be understood that the summary may be generated based on an automated function, wherein the automated function may generate the summary periodically, may generate the summary when the usage of one or more of the firewall rules satisfies criteria, or may be generated at any other interval.

In some implementations, once the summary is displayed via a user interface, a user may make modifications to the firewall rules. The modifications may include changing the sequence of the firewall rules in firewall 120, may include removing one or more firewall rules for firewall 120, or may comprise some other modification. In some implementations, the summary may indicate suggested modifications to the firewall rules, wherein the suggestions may be triggered based on the usage associated with one or more firewall rules. As an example, firewall rules that have no or little usage may be identified to be moved lower in the sequence of firewall rules, removed from the firewall entirely, or modified to create additional usage. In some implementations, monitor service 111 may implement the changes to the firewall rules sequence automatically without user input.

FIG. 2 illustrates an operation 200 to monitor and summarize firewall rule statistics according to an implementation. The steps of operation 200 are referenced parenthetically in the paragraphs that follow with reference to systems and elements of computing environment 100 of FIG. 1.

As depicted, summary service 111 performs operation 200, wherein operation 200 includes identifying (201) a sequence for applying firewall rules to communications in a computing network. In some implementations, firewall 120 may be configured to manage segmentation and security for computing nodes 122, wherein computing nodes 122 may comprise physical computing systems or logical endpoints, such as virtual machines or containers. Each of the firewall rules may associate attributes identifiable in a communication packet with an action. For example, when a packet is identified in computing network 112, firewall 120 may extract source and destination addressing information (attributes) from the packet and compare the addressing information to firewall rules until a match is identified. When comparing the addressing information, each of the rules may be compared in a sequence or order until an applicable rule is identified. Once a rule is identified, firewall 120 may implement the action associated with the rule and stop comparing the attributes of the packet to the attributes of the remaining firewall rules. In some computing environments, a firewall may be a distributed across multiple host computing systems or other networking elements, however, it should be understood that a firewall may be implemented in a single computing element.

In addition to identifying a sequence of firewall rules, operation 200 further monitors (202) usage associated with each firewall rule of the firewall rules in the computing network. The usage may be based on total number of hits over a given period, a ratio of hits per rule as a function of total hits, or some other usage statistic. In some examples, the usage information may be obtained from multiple hosts or computing systems that provide the distributed firewall for a computing environment. The usage statistics may be provided periodically, at request of the summary service, or at some other interval, wherein the summary service may store the statistics in one or more data structures or log files. As the usage statistics are monitored for the firewall rules, summary service 111 generates (203) a summary to indicate the sequence of the firewall rules with the usage associated with each of the firewall rules. In some implementations, the summary is generated based on a user request. In other implementations, the summary may be generated automatically, based on the usage of the firewall rules meeting one or more criteria, or based on some other action.

As an example, an administrator associated with computing network 112 may request usage information for a set of firewall rules implemented by firewall 120. In response to the request, summary service 111 may identify usage associated with each firewall rule in the set of firewall rules and generate a summary for the administrator. The summary may comprise a visual representation of the sequence for the firewall rules and, for each firewall rule in the sequence, usage associated with the firewall rule. As depicted in summary 130, a summary may comprise a graph, wherein the graph may indicate the sequence for applying the firewall rules and the corresponding usage for each or the firewall rules. The usage may represent a total quantity of hits associated with the rule, a ratio of hits as a function of time, or some other usage statistic. In the example of summary 130, the graph may be represented as a bar graph, where rules with a higher usage may correspond to a larger height or length than the rules with a lower usage. Thus, rules 150 and 154 are demonstrated with a longer length than the other rules in the summary.

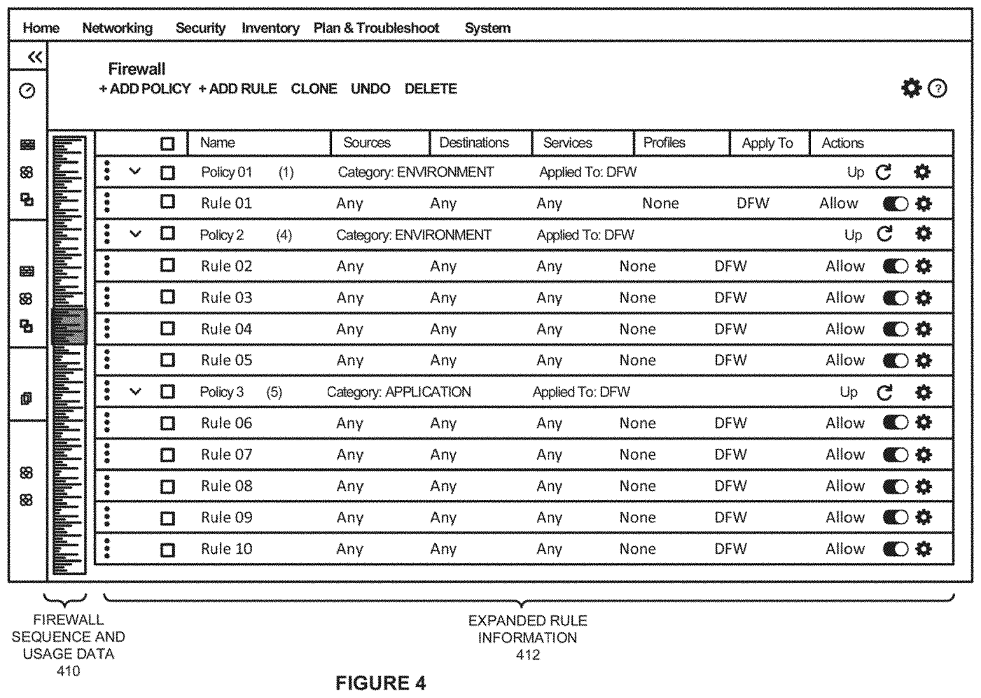

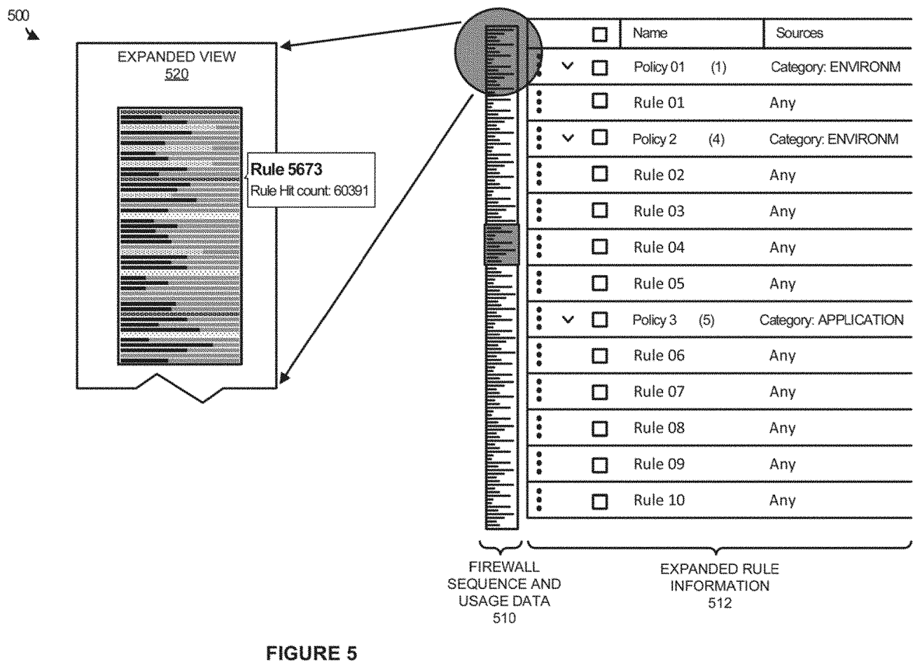

In some implementations, the summary may be used to promote specific rules or usage information to the user. Summary service 111 may compare the usage for the firewall rules to criteria to determine one or more firewall rules of interest. These firewall rules may include rules that satisfy a threshold amount of usage, firewall rules that fail to satisfy a threshold amount of usage, or some other criteria of interest. As an example, summary service 111 may determine when one or more of the firewall rules have not had any usage within a time period. The identified rules may then be promoted in summary 130, such that the user can more easily identify the relevant rules. In promoting the rules, the rules may be highlighted, presented in a different color, expanded, or provided in some other manner so as to be promoted differently over the other firewall rules. For example, rules that exceed or fall below a threshold amount of usage may be presented in a different color than other firewall rules in the graphical representation or mini-maps of the rules. The promotion may be indicated by color, bolding, or otherwise promoting items within the mini-map or graph or may be promoted using pop-ups or some other expansion of information for the relevant rules. A further example is depicted in FIGS. 4 and 5, where the user may use a slider, selection box, search, or other selection mechanism to identify rules of interest to the user.

In some examples, when summary 130 is provided to a user, the user may implement modifications to the firewall rules sequence based on the summary. The modifications may include changing the sequence that the firewall rules are applied, removing firewall rules from the sequence, adding firewall rules to the sequence, or providing some other modification to the firewall configuration. In some implementations, rather than using an administrator to implement the changes to the configuration, summary service 111 may determine changes to the configuration without user input. For example, summary service 111 may determine when usage associated with one or more of the firewall rules satisfy criteria and may modify the firewall rules sequence based on the satisfied criteria. The criteria may comprise a threshold quantity of hits, a threshold ratio of hits in relation to a total number of hits, or some other criteria.

In some implementations, summary service 111 may provide a user with a drop-down menu, a tool bar, or some other selector tool that permits the user to provide preferences for the summary. The preferences may include usage preferences, wherein the user may select a unit for the usage of the firewall rules (total hits, total bytes, etc.), and may further be used to select or identify a subset of the firewall rules for the summary. In selecting the firewall rules for the summary, the user may select firewall rules that meet criteria, such as minimum usage criteria, maximum usage criteria, and the like, may select firewall rules based on when the firewall rules were last changed or added, or may select a subset of firewall rules in some other manner.

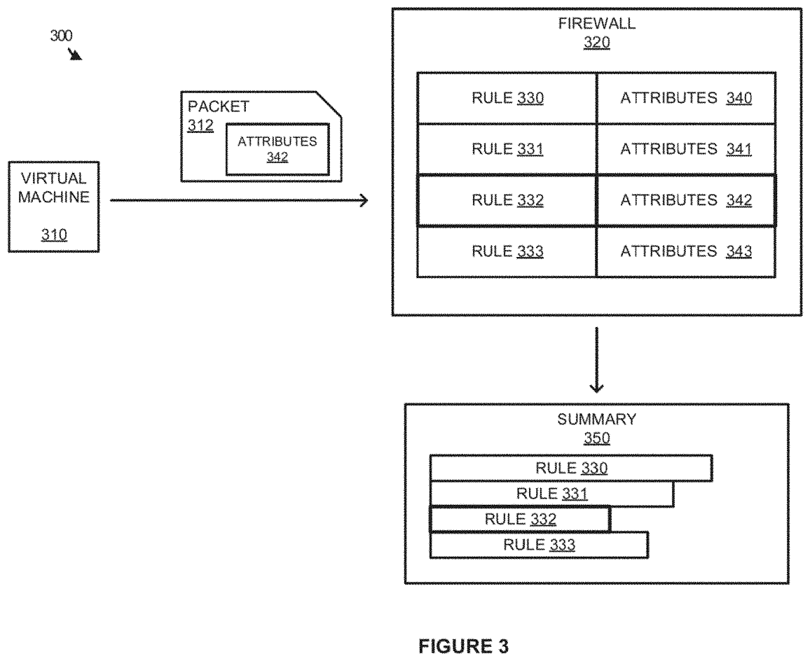

FIG. 3 illustrates an operational scenario 300 of generating a summary from firewall rule statistics according to an implementation. Operational scenario 300 includes virtual machine 310, packet 312, firewall 320, and summary 350. Packet 312 includes attributes 342, firewall 320 implements firewall rules 330-333 that each correspond to attributes 340-343, and summary 350, which includes usage statistical information associated with rules 330-333. Although demonstrated with a packet originating from a virtual machine, it should be understood that a packet may originate from a container, a physical computing system, or some other endpoint.

In operation, firewall rules 330 are applied by a firewall to provide segmentation and security for a computing network. Each firewall rule is used to associate attributes identified in communication packets with an action for the packet. Attributes 340-343 associated with rules 330-333 may include addressing attributes, protocol attributes, or some other attributes identifiable in a communication. In at least one example, attributes defined for a rule may correspond to security group tags allocated to endpoints in the network, wherein the security groups may be used to group one or more endpoints based on the function provided by the endpoints. For example, endpoints that provide a front-end service may be associated with a first security group and first security group identifier, while endpoints that provide database services may be associated with a second security group and second security group identifier. The firewall rules may then associate source and/or destination security groups with actions based on the security groups. For example, a firewall rule may block all communications between a front-end security group and a database security group. In some examples, the firewall rules may be translated into a data plane configuration that permits the firewall to identify packets associated with the security groups. This may include identifying IP addresses associated with the security groups, MAC addresses associated with the security groups, or some other attribute associated with endpoints in each of the security groups.

Here, when virtual machine 310 generates packet 312, firewall 320 may identify attributes 342 in the packet and determine which of the firewall rules applies to the packet. In comparing the attributes to the firewalls, firewall 320 may compare each of the rules in the sequence defined by the configuration for the firewall. Thus, while firewall rules 330-331 do not apply, firewall rule 332 does apply as a result of attributes 342. Once a firewall rule is identified, which classifies as a hit, the firewall may apply the required action to packet 312 and stop the traversal of any remaining rules. Additionally, when summary 350 is generated, the usage associated with rule 332 may indicate the identified hit along with other usage information associated with rules 330-333.

Although demonstrated as requiring attributes 342 to apply rule 332 to a packet, it should be understood that additional attributes may also be identified to apply rule 332. Returning to the example of security groups, a firewall rule may apply to multiple IP addresses, MAC addresses, and the like that correspond to a security group or groups (e.g., source and destination security groups). As a result, rule 332 may apply to any packet with addressing attributes for computing nodes associated with the security group or groups.

Although demonstrated in operational scenario 300 as a bar graph, it should be understood that the usage statistics may be displayed using other graphs or visual representations. Other visual representations may include a list, a table, or some other summary capable of indicating the sequencing for the firewall rules and usage statistics associated with each of the firewall rules. In some implementations, summary 350 may promote firewall rules of interest based on the firewall rules of interest satisfying criteria. The criteria may comprise an amount of usage, a lack of usage, or some other criteria. For example, criteria may be used to identify firewall rules that have not received a hit and the summary may promote the identified rules, wherein promoting the rules may include highlighting the rules, highlighting portions of the bar graph associated with the rules, or providing some other operations to promote the identified rules. For example, the promotion of relevant rules or rules of interest may be accomplished by increasing the size of bar in the graph, changing the color of the bar in the graph, or providing some other promotion. In other examples, information about relevant rules may be expanded, wherein the information may include statistics, rule information (source, destination, and the like) or some other expanded information.

In some implementations, when a user requests the generation of the summary, the user may select the firewall rules that are relevant to the query, any criteria for firewall rules to be promoted in the summary, or some other information about the desired summary. For example, a user may request all firewall rules that have not received a hit during a time period. In response to the request, the firewall summary service may identify firewall rules that satisfy the request and generate a summary that includes that corresponding rules. The summary may include sequencing information for the identified rules, attributes (addressing, security group, and the like) for the identified rules, or some other information associated with the rules.

FIG. 4 illustrates a summary according to an implementation. The summary includes firewall sequence and usage data 410 and expanded rule information 412. Firewall sequence and usage data 410 comprises a bar chart or mini-map, wherein each bar of the bar chart corresponds to a firewall rule and is organized based on the sequence for which the firewall rules are applied for a computing network. The length or size of each of the bars corresponds to a usage associated with the firewall rule. The firewall rules with more hits or usage may have a longer length bar compared to firewall rules with less hits or usage. The usage may comprise a total number of hits for each firewall rule, a ratio of hits for the firewall rule in relation to the total number of hits for the firewall, a quantity of bites or packets identified for each of the firewall rules, or some other usage metric.

As depicted in the summary, a portion of the firewall rules may be selected and provided as expanded rule information 412, wherein the user may use a slider, a drop-down menu, or some other selection mechanism associated with firewall sequence and usage data 410 to identify a subset of the firewall rules of interest to the user. Expanded rule information 412 includes names for the rules and additional attributes corresponding to the rules of interest, wherein the additional attributes include sources (IP/MAC addresses, security groups, and the like), destinations (IP/MAC addresses, security groups, and the like), services, profiles, and actions. Also depicted in expanded rule information 412 are policy identifiers or names, which can be used to segment the different firewall rules of the computing network.

In some implementations, when the summary is provided to a user, the user may use the summary to change the firewall configuration based on the usage data. The modifications may include moving firewall rules, or entire policies, within the sequence, removing one or more firewall rules, adding one or more firewall rules or providing some other configuration update. The configuration change may then be distributed via the control plane to the one or more physical computing elements implementing the firewall for the computing network. The control plane is used to carry signaling traffic for the computing network and manage the configuration of the data plane, wherein the data plane interacts with the traffic of the endpoints in the computing network.

In some implementations, a user may generate a request for the summary and indicate preferences associated with the summary. The preferences may indicate the desired usage information for the firewall rules (total number of hits, total number of bites, and the like), criteria for specific firewall rules of interest or firewall rules that meet criteria, or some other preference for the summary. Based on the preferences, the summary service may select the subset of the firewall rules associated with the preferences and provide usage information associated with the subset of the firewall rules. For example, a user may request sequencing information associated with firewall rules the usage under a threshold amount. In some examples, the summary may be generated without the request of the user, wherein the summary may be generated periodically, based on one or more of the firewall rules satisfying criteria, or for some other reason. When a summary is generated, the firewall summary service may distribute a notification to a user, indicating the summary and the user may view the corresponding summary.

In some examples, firewall sequence and usage data 410 may provide other information in addition to, or in place of, the usage information. This information may include identifiers for firewall rules that were changed within a recent time period, identifiers for rules that were recently added, or some other information associated with the firewall rules. For example, a user may request to identify all rules that were added or modified in the last day. In response to the request, a subset of the firewall rules may be identified and flagged or otherwise identified in the sequence of the firewall rules displayed as part of firewall sequence and usage data 410.

FIG. 5 illustrates an overview 500 of a summary according to an implementation. Overview 500 includes firewall sequence and usage data 510 and expanded rule information 512 that may each be displayed as part of a summary to an end user. Overview 500 further includes expanded view 520, which further demonstrates a specific portion of firewall sequence and usage data 510.

As described herein, a firewall summary service may generate a summary to indicate the usage of firewall rules for a computing network. Here, the summary includes firewall sequence and usage data 510 and expanded rule information 512. Firewall sequence and usage data 510 includes a chart or mini-map that graphically represents the sequence of which firewall rules are applied to communications in the computing network and further demonstrates the usage associated with each of the rules. The usage, represented by the length of the bars in the chart, may represent the quantity of hits associated with each of the rules, the ratio or percentage of hits for the rule in relation to the total number of hits in the firewall, or some other usage statistic. The chart or graph in firewall sequence and usage data 510 is further demonstrated in expanded view 520, wherein a hit count is provided in association with a rule. In some examples, a user may interact with the summary to provide specific statistics in association with one or more rules, wherein the statistics may be expanded to demonstrate the rule identifier, the hit count associated with the rule, the total number of hits for the firewall, or some other information in association with the one or more selected rules.

In overview 500, a selection may be made of a subset of the rules and expanded rule information may be provided as expanded rule information 512. The selection may be made via slider, a highlight operation, or some other selection mechanism. Expanded rule information 512 may include the name or identifier associated with the firewall rule, source attribute information for the firewall rule, destination attribute information for the firewall rule, or some other information associated with the firewall rule. In some examples, the firewall rules may be divided into multiple sections known as policies, wherein policies may be defined by an administrator associated with the computing network.

In some examples as part of the summary, the display may permit the user to select configuration changes to the firewall. The configuration changes may include adding firewall rules, removing firewall rules, changing the sequencing associated with the firewall rules, or performing some other action. Accordingly, based on the statistics provided in firewall sequence and usage data 510, an administrator associated with the computing network may update the firewall, such that firewall rules with a greater usage are promoted over firewall rules with lesser usage. The user may also identify problems with rules that are never hit or are overly hit.

In some implementations, in addition to or in place of the usage statistics, the summary may provide other information about the firewall configuration. The other information may include recently modified firewall rules, recently added firewall rules, or some other information associated with the firewall rules. In one example, a drop-down menu, tool bar, or some other selection mechanism may be provided to the user to obtain preferences for a summary. In response to a user selection, the summary may include additional information with the sequence of the firewall rules. In some implementations, rules that satisfy the user requirements or criteria may be flagged, highlighted, or otherwise promoted in the summary, such as in firewall sequence and usage data 510. Thus, if the user requested identification of recently modified firewall rules, the recently modified firewall rules may be flagged in firewall sequence and usage data 510 for the user.

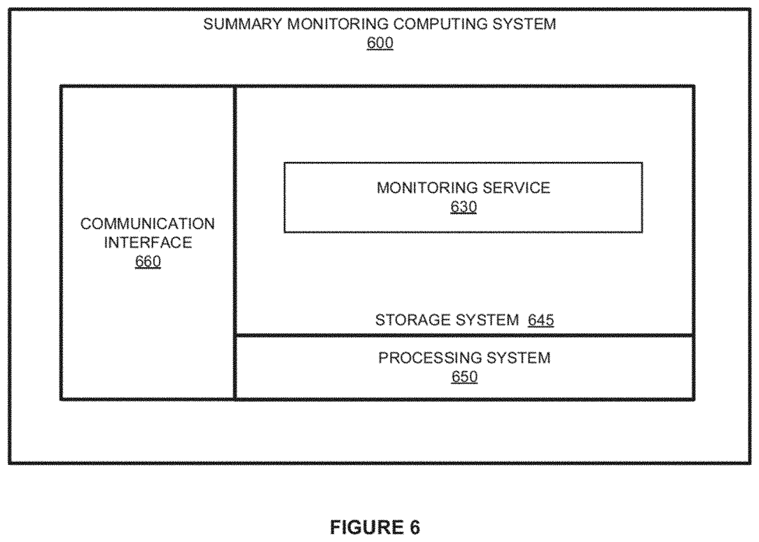

FIG. 6 illustrates a firewall summary computing system 600 according to an implementation. Computing system 600 is representative of any computing system or systems with which the various operational architectures, processes, scenarios, and sequences disclosed herein for a gateway can be implemented. Computing system 600 is an example computing system for summary service 111 of FIG. 1, although other examples may exist. Computing system 600 includes storage system 645, processing system 650, and communication interface 660. Processing system 650 is operatively linked to communication interface 660 and storage system 645. Communication interface 660 may be communicatively linked to storage system 645 in some implementations. Computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 may be configured to communicate with computing systems that provide the firewall services for the computing network and may further be configured to communicate with one or more console devices to provide a summary associated with the firewall usage for the computing network.

Processing system 650 comprises microprocessor and other circuitry that retrieves and executes operating software from storage system 645. Storage system 645 may include volatile and nonvolatile, removable and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises summary service 630 capable of providing operation 200 of FIG. 2. The operating software on storage system 645 may further include an operating system, utilities, drivers, network interfaces, applications, or some other type of software. When read and executed by processing system 650 the operating software on storage system 645 directs computing system 600 to operate as described herein.

In at least one implementation, summary service 630 directs processing system 650 to identify a sequence for applying firewall rules to communications in a computing environment. In some implementations, the sequence may comprise all firewall rules for the computing network, however, in other examples, the sequence may comprise a subset of the firewall rules. Summary service 630 further directs processing system 650 to monitor usage associated with each firewall rule of the firewall rules in the computing network, wherein the usage may comprise total number of hits, a ratio of hits for each rule as a function of total hits, or some other usage statistics. In some implementations, the usage may be maintained for a total uptime of the computing network, but it should be understood that the usage may be maintained for a more recent period.

As the usage statistics are maintained, summary service 630 directs processing system 650 to generate, for display, a summary to indicate the sequence of the firewall rules with the usage associated with each of the firewall rules. In some examples, the summary may comprise a graph, wherein the graph may be organized to display the sequence of the firewall rules and the usage associated with firewall rules as bar graph or some other graph. The summary may further demonstrate or promote one or more firewall rules of the firewall rules that satisfy one or more criteria based on the usage associated with the one or more firewall rules. For example, for a bar graph, firewall rules with usage that satisfies one or more criteria may be promoted, wherein the promotion may include indicating the usage in a different color, bolding or increasing the size of the bar in the bar graph, or providing some other notification to promote the one or more firewall rules. Advantageously, firewall rules that exceed a usage threshold may be quickly identified for an administrator, permitting the user to identify statistics of interest for the firewall.

In some examples, the user may set one or more criteria for generating the summary, wherein the one or more criteria may comprise usage requirements associated with the firewall rules, sequence requirements for the firewall rules (e.g., first twenty rules), or some other criteria for the summary. Based on the one or more criteria, summary service 630 may select firewall rules for the summary and generate the summary with the selected firewall rules. The rules may be arranged in the summary based on the sequence for the firewall rules and may indicate the usage associated with each of the firewall rules.

In some examples, the summary may permit a user to select a subset of firewall rules for additional information. The selection may be made using a slider on full list of firewall rules, a text box, or some other selection mechanism for the firewall rules. The additional information may provide further context for the usage of the subset, may provide information about the attributes associated with the firewall rule, provide information about the action for the firewall rule, or provide some other information associated with the subset.

In some implementations, an administrator may interact with the summary to provide updates to the firewall configuration. The updates may be used to add one or more firewall rules, remove one or more firewall rules, change the sequence associated with the firewall rules, or provide some other operation with the firewall configuration. In some examples, the summary may indicate suggestions to modify the firewall configuration, wherein firewall rules with a higher usage may be suggested to be moved earlier in the sequencing of the firewall rules. Additionally, in some examples, rather than providing a suggestion to an administrator using the summary, summary service 630 may automatically make changes to the firewall configuration based on firewall usage satisfying one or more criteria. For example, if a firewall exceeds a usage threshold, summary service 630 may make one or more modifications to the configuration to move the firewall rule earlier in the sequence of the firewall rules.

In some examples, the summary may be generated and displayed using firewall summary computing system 600. In other examples, firewall summary computing system 600 may generate the summary and communicate the summary to a console device associated with an administrator for the computing network. The console device may comprise a desktop computer, laptop computer, tablet, or some other computing device. The summary may be provided via a web browser, a dedicated application, or some other service on the console device.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
identifying a sequence for applying firewall rules to communications in a computing network;
monitoring usage associated with each firewall rule of firewall rules in the computing network; and
generating, for display, a summary to indicate the sequence of the firewall rules with the usage associated with each of the firewall rules.

2. The method of claim 1 further comprising:
identifying a selection of the firewall rules from a set of firewall rules; and
generating the summary in response to the selection.

3. The method of claim 1, wherein the usage comprises a quantity of hits associated with each firewall rule of the firewall rules.

4. The method of claim 1, wherein the usage comprises a ratio of hits in relation to a total quantity of hits.

5. The method of claim 1 further comprising:
identifying one or more firewall rules of the firewall rules with usage that satisfies at least one usage criterion; and
promoting the one or more firewall rules in the summary over remaining firewall rules of the firewall rules.

6. The method of claim 1 further comprising:
identifying one or more sequence changes for the sequence based on the usage associated with each firewall rule of the firewall rules; and
indicating the one or more sequence changes in the summary.

7. The method of claim 1 further comprising displaying the summary or communicating the summary to a client device for display by the client device.

8. The method of claim 1 further comprising:
identifying one or more sequence changes for the sequence based on the usage associated with each firewall rule of the firewall rules; and
implementing the one or more sequence changes to the sequence.

9. The method of claim 1, wherein the summary comprises a bar chart, wherein each bar of the bar chart corresponds to a firewall rule of the firewall rules, wherein the bars are organized to indicate the sequence of the firewall rules, and wherein the height or length of each of the bars corresponds to the usage of a firewall rule represented by the bar.

10. The method of claim 1, wherein the summary further indicates attributes associated with one or more of the firewall rules, wherein the attributes may comprise a firewall rule identifier, a source identifier, or a destination identifier.

11. A computing apparatus comprising:
a storage system;
a processing system operatively coupled to the storage system; and
program instructions stored on the storage system that, when executed by the processing system, direct the computing apparatus to:
identify a sequence for applying firewall rules to communications in a computing network;
monitor usage associated with each firewall rules of the firewall rules in the computing network; and
generate, for display, a summary to indicate the sequence of the firewall rules with the usage associated with each of the firewall rules.

12. The computing apparatus of claim 11, wherein the program instructions further direct the computing apparatus to:
identify a selection of the firewall rules from a set of firewall rules; and
generate the summary in response to the selection.

13. The computing apparatus of claim 11, wherein the usage comprises a quantity of hits associated each firewall rule of the firewall rules.

14. The computing apparatus of claim 11, wherein the usage comprises a ratio of hits in relation to a total quantity of hits.

15. The computing apparatus of claim 11, wherein the program instructions further direct the computing apparatus to:
identify one or more firewall rules of the firewall rules with usage that satisfies at least one usage criterion; and
promote the one or more firewall rules in the summary over remaining firewall rules of the firewall rules.

16. The computing apparatus of claim 11, wherein the program instructions further direct the computing apparatus to:
identify one or more sequence changes for the sequence based on the usage associated with each firewall rule of the firewall rules; and
indicate the one or more sequence changes in the summary.

17. The computing apparatus of claim 11, wherein the program instructions further direct the computing apparatus to display the summary or communicate the summary to a client device for display by the client device.

18. The computing apparatus of claim 11, wherein the program instructions further direct the computing apparatus to:
identify one or more sequence changes for the sequence based on the usage associated with each firewall rule of the firewall rules; and
implement the one or more sequence changes to the sequence.

19. The computing apparatus of claim 11, wherein the summary comprises a bar chart, wherein each bar of the bar chart corresponds to a firewall rule of the firewall rules, wherein the bars are organized to indicate the sequence of the firewall rules, and wherein the height or length of each of the bars corresponds to the usage of a firewall rule represented by the bar.

20. An apparatus comprising:
a storage system; and
program instructions stored on the storage system that, when executed by a processing system of a computing system, direct the computing system to:
identify a sequence for applying firewall rules to communications in a computing network;
monitor usage associated with each firewall rules of the firewall rules in the computing network; and
generate, for display, a summary to indicate the sequence of the firewall rules with the usage associated with each of the firewall rules, wherein the summary comprises a graph or chart.
